(19) United States
(12) Patent Application Publication
(10) Pub. No.: US 2007/0270066 A1
(43) Pub. Date: Nov. 22, 2007

(54) HYDROPHILIC BINDER FOR AGRICULTURAL PLANT GROWTH SUBSTRATE

(75) Inventors: Hendrikus W.G. Van Herwijnen, Hausleiten-Goldgeben (AT); Elena Pisanova, Mississauga (CA); Alexander Tseitlin, Mississauga (CA); Rob Schmidt, Mississauga (CA)

Correspondence Address: BIRCH STEWART KOLASCH & BIRCH, PO BOX 747, FALLS CHURCH, VA, 22040-0747, US

(73) Assignee: Dynea Austria GmbH, Krems (AT)

(21) Appl. No.: 11/744,686

(22) Filed: May 4, 2007

Related U.S. Application Data
(60) Provisional application No. 60/797,675, filed on May 5, 2006.

(51) Int. Cl. B32B 17/02; B32B 5/02

(52) U.S. Cl. 442/180; 427/372.2; 427/212; 442/172

(57) ABSTRACT

A hydrophilic plant growth substrate formed with a formaldehyde-free curable aqueous binder. The formaldehyde-free curable aqueous binder is formed in a process comprising combining the following components: (a) a hydroxy-containing polymer, (b) a multi-functional crosslinking agent winch is at least one selected from the group consisting of a polyacid salt(s) thereof and anhydride, and (c) a hydrophilic modifier. The hydrophilic plant growth substrate has excellent properties and is made in an environmentally friendly process.

This Nonprovisional application claims priority under 35 U.S.C. § 119(e) on U.S. Provisional Application No. 60/797,675 filed on May 5, 2006, the entire contents of which are hereby incorporated by reference.

### FIELD OF THE INVENTION

This invention relates to a non-formaldehyde hydrophilic binder for agricultural plant growth substrate. More particularly, the invention pertains to thermosetting self-crosslinking resins comprising an infinitely water-dilutable aqueous solution of a hydroxy-containing polymer, multi-functional crosslinking agent and a hydrophilic modifier.

### BACKGROUND OF THE INVENTION

Conventional plant growth substrates are manufactured of mineral wool (this can be glass wool, rock wool, slag wool) connected by cured binder, which is usually phenol-formaldehyde (PF) resins. Such resins are inexpensive, have low viscosity, and cure to form a rigid polymer, thereby providing the finished product with excellent physical properties. The material thus produced has a very hydrophobic character. This is ideal for insulation against heat, cold, or sound as the uptake of water would decrease the insulation properties.

However, this hydrophobic property creates complications for use of such wool as a growth medium. In order to make the wool suitable for agricultural and horticultural purposes, a wetting agent has to be added to the phenolic binder to make the wool hydrophilic. Only a limited number of wetting agents can be used, as it must be possible to atomize the agent in order to spray it homogeneously onto the wool. The use of wetting agents has several disadvantages. The main disadvantage is that the wetting agent may have toxic effects due to its decomposition, and may leach out of the plant growth substrate. This means that over a period of time, the wetting agent is removed out of the matrix of the mineral wool, and the plant growth substrate loses its hydrophilic properties.

A serious disadvantage of PF resins is the presence and production of high concentrations of free formaldehyde, which is undesirable for ecological reasons. During the curing reaction, formaldehyde and low molecular weight phenol-formaldehyde compounds are volatilized from the binder into the surrounding environment.

Mineral wool substrates for plant growth are known in the art and consist of a regular matrix of mineral wool such as glass wool, rock wool, slag wool, and/or mixtures thereof. This matrix is formed by spraying a layer of mineral wool fiber with aqueous binder solution followed by curing at elevated temperature.

A number of compositions have been developed for use as a hydrophilic plant growth substrate.

GB 1,336,426 patent describes use of phenol-formaldehyde binder for manufacturing mineral wool medium for soilless plant growth. However, in order to impart hydrophilic properties of the medium, a wetting agent was added.

U.S. Pat. No. 6,042,630 and U.S. Pat. No. 6,183,531 disclose the use of organic additives, which provide water retaining capacity as well as pH control.

WO 97/07664 discloses the manufacture of mineral wool plant growth substrate using a furan resin as a binder. The use of furan resin binder allows the abandonment of the use of wetting agents. However, such resins are relatively expensive.

U.S. Pat. No. 6,562,267 describes a combined binder consisting phenol-formaldehyde and furan resin. Sugar and ammonia may be added to the binder to decrease formaldehyde emissions and improve final properties.

EP 0 631 466 describes a cultivating medium for plants consisting of bonded mineral wool. The mineral wool is combined with polysaccharides so that the mineral wool fibers are embedded in a polysaccharide matrix. This results in a physical bonding, and not a chemical bonding. These polysaccharides are not soluble in cold water. However, such chemicals are soluble in hot water, so the wool would likely collapse under such conditions as would be exhibited in glass houses.

Despite these disclosures, there is a growing need for improved formaldehyde-free aqueous compositions suitable for use as a plant growth media. Thus, the present invention fills that need by providing binders having hydrophilic properties of the cured product using formaldehyde-free aqueous compositions.

### SUMMARY OF THE INVENTION

The present invention is drawn to a curable aqueous composition for use in a plant growth substrate and a method for preparing said curable aqueous composition comprising the following steps: combining (a) a hydroxy-containing polymer, (b) a multi-functional crosslinking agent which is at least one selected from the group consisting of a polyacid, salts(s) thereof, and an anhydride, and (c) a hydrophilic modifier; and with the proviso that if the curable aqueous composition has a pH of below 1.25, then the method further comprises a step of adding sufficient base to raise the pH to at least 1.25; and wherein the weight ratio of (a):(b) is from 95:5 to about 35:65.

Embodiments of the present invention include a plant growth substrate and a method of forming said plant growth substrate, wherein said method comprises combining a nonwoven fiber in said curable aqueous composition and heating to effect cure to form said plant growth substrate.

Further scope applicability of the present invention will become apparent from the detailed description give hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

An embodiment of the present invention is a curable aqueous composition for use in a plant growth substrate, wherein said curable aqueous composition is formed in a process comprising combining the following components: (a) a hydroxy-containing polymer, (b) a multi-functional crosslinking agent which is at least one selected from the group consisting of a polyacid, salt(s) thereof and an anhydride, and (c) a hydrophilic modifier; and wherein the weight ratio of (a):(b) is from 95:5 to about 35:65.

The (a) hydroxy-containing polymer is preferably a polyvinyl alcohol (hereinafter PVOH). It was found that some grades of PVOH work better than others. Those grades having a molecular weight classification of medium or high are not preferred as they impart excessive viscosities to the binder. It is preferred to use a low-molecular weight PVOH defined as having viscosity of up to 10 centipoise in a 4% aqueous solution at 20° C.

Generally, PVOH is prepared as a partially hydrolyzed polyvinyl acetate, or as the copolymer of ethenol and vinyl acetate. Fully hydrolyzed grades of PVOH, i.e., at least 98 mole % hydrolyzed, provide high tensile strength of the final product. However, these fully hydrolyzed grades are characterized by a higher viscosity of aqueous solutions. It is preferred that the PVOH is from 70 mole % to 99 mole % and more preferably from 80 mole % to 90 mole % hydrolyzed.

The (b) multi-functional crosslinking agent is an acid comprising at least two carboxylic groups, an anhydride, or salt(s) thereof. It is preferred that the multi-functional crosslinking agent is at least one selected from the group consisting of citric acid, maleic acid, maleic anhydride, succinic acid, glutaric acid, malic acid, phthalic acid, and phthalic anhydride.

The (c) hydrophilic modifier can be any compound that when added to components (a) and (b), increases the hydrophilicity of the overall composition and is compatible therewith. It is preferred that the (c) hydrophilic modifier is at least one low-molecular weight polyol compound selected from the group consisting of a sugar alcohol (such as sorbitol or glycerol), a monosaccharide, disaccharide and oligosaccharide. More preferably, the (c) hydrophilic modifier is at least one compound selected from the group consisting of glucose, fructose, sucrose, maltose, lactose, sorbiol, glycerol, glucose syrup and fructose syrup. It is most preferred to use the glucose syrup or fructose syrup for cost considerations and ease of mixing.

Preferably, the relative amounts of (c) a hydrophilic modifier and (a) a hydroxy-containing polymer are combined in a ratio of at most 60 parts by weight (c)/40 parts by weight of (a). More preferably, the ratio is 5 parts (c)/95 parts (a) to 50 parts (c)/50 parts (a). Most preferably, the ratio is 15 parts (c)/85 (a) to 40 parts (c)/60 parts (a).

In an embodiment of the invention, the curable aqueous composition is a concentrated solution and is produced having a non-volatiles content of greater than 25 wt %. Preferably, the non-volatiles content is greater than 30 wt %, and most preferably, the non-volatiles content is 32 wt % to 43 wt % based on the weight of the concentrated resin composition. This concentrated resin composition is a clear solution and is substantially infinitely water-dilutable. The concentrated form of the resin allows for easy storage and handling.

The nonwoven fiber can be any material so long as it provides sufficient strength to the plant growth substrate to prevent easy breakage. Such strength is achieved when the individual fibers are of sufficient length to substantially intertwine. The preferred nonwoven fibers are fiberglass and/or mineral wool.

An embodiment of the present invention is a method of forming a plant growth substrate comprising the following steps: combining (a) a hydroxy-containing polymer, (b) a multi-functional crosslinking agent which is at least one selected from the group consisting of a polyacid, salt(s) thereof, and an anhydride, and (c) a hydrophilic modifier, and with the proviso that if the curable aqueous composition has a pH of below 1.25, then the method further comprises a step of adding sufficient base to raise the pH to at least 1.25; and combining the curable aqueous composition with the nonwoven fiber, and heating the curable aqueous composition and the nonwoven fiber at 150° C. to 200° C. for sufficient time to effect cure, wherein the weight ratio of (a):(b) is form 95:5 to about 35:65. Once cured, the combination of (a) a hydroxy-containing polymer, (b) a multi-functional crosslinking agent and (c) a hydrophilic modifier form a rigid thermoset polymer.

The inventive method can include a step of diluting the curable aqueous composition with sufficient water so the curable aqueous composition has 95% by weight of water prior to the heating step. Preferably, the diluted resin form comprises greater than 1% by weight of nonvolatiles immediately prior to curing. More preferably, the diluted resin form comprises 2 to 12% by weight of nonvolatiles immediately prior to curing. Most preferably, the diluted resin form comprises 3 to 6% by weight of nonvolatiles immediately prior to curing.

Upon curing of the binder, the final plant growth substrate product preferably contains up to 10 wt % of cured polymer, more preferably from 2 wt % to about 8 wt % of cured polymer, wherein the wt % is based on the amount of fiber and cured polymer. The amount of cured polymer can be optimized based on the type of nonwoven fiber used. It is preferred that the final plant growth substrate product has about 2-5 wt % cured polymer when mineral wool is used as the nonwoven fiber. It is envisioned that the fiber surface can be pretreated prior to application of the binder, e.g., with adhesion promoters, however, this is not preferred in view of the cost of this step.

The curable aqueous binder is applied to the nonwoven fibers and is cured in a traditional way. The cured polymer is highly hydrophilic and this characteristic is transferred to the nonwoven fiber (e.g., wool). This allows the avoidance of wetting agents and reduces toxic emissions during the manufacturing process.

### EXAMPLE 1

A 20% aqueous solution (by weight) of PVOH (Celvol 205S, by Celanese, 88.5% hydrolyzed) was used for the binder preparation.

625 g of PVOH solution were charged into a 2 liter resin kettle equipped with a mechanical stirrer, a condenser and a heater. 125 g of solid maleic anhydride were added at mixing at room temperature. Then the temperature was raised to 60° C. and the composition was mixed until anhydride was dissolved. 50 g of solid citric acid and 63 g of 80% glucose syrup were added and mixed for 15 minutes. The liquid was cooled to 25° C. and neutralized with Aqua Ammonia. The product was a colorless clear liquid of pH 3.5 and solid content 37.5%.

### EXAMPLE 2

Binder Preparation

The resin of Example 1 was used for binder preparation (Binder A).

As a comparative example, phenol-formaldehyde resin 60-600 (Dynea Canada Ltd) was used. The binder was prepared using solid urea at 70:30 resin/urea ratio (Binder B). Both binders were diluted by water to 5% by weight and used for application onto glass fiber and mineral wool substrates.

### EXAMPLE 3

Tensile Testing of Cured Glass Fiber Specimens

The binder of Example 2 was diluted to 5% solids and was applied to a glass fiber substrate. Glass paper (Whatman 934-AH) was soaked in the binder solution for 5 minutes, then the excess of liquid was removed by vacuum. Samples were put into the oven at 180° C. for 5 minutes.

The cured samples were cut into specimens 6″×1″ and tested for dry tensile strength. Fore wet tensile testing, the specimens were treated by hot water at 80° C. for 10 minutes, and then tested. The load in Kgf was measured at the break.

Water absorption was estimated by the time needed for absorption of one droplet of water. The test results are presented in the Table 1.

TABLE 1

| | Dry strength, | Wet strength, | Water absorption, |
|---|---|---|---|
| Binder # | kgf | kgf | min |
| A | 6.2 | 4.1 | 2 |
| B | 6.3 | 3.8 | (a) |

(a) it was found that water absorption did not occur even at 48 minutes.

### EXAMPLE 4

Production trials were conducted using both inventive (A) and comparative (B) binders on mineral wool and glass fiber substrates. The hydrophilic properties of the manufactured mats were estimated by a sinking test.

The sinking test is an empirical test used to measure the relative hydrophilicity of the sample. This test includes measuring the amount of time required to sink a sample cut in a one (1) inch cube in room temperature water.

While comparative sample showed a high hydrophobicity and was floating on the water surface, the inventive sample was sinking within 15 sec.

### EXAMPLE 5

A plant growth substrate in the form of grow blocks was prepared using the product form the trial. These blocks were used for growing garden cress (lepidium savitum). In a second experiment, tomatoes (hycopersicon esculentum) are grown onto the wool.

During culturing, the optimal control of pH buffering and water distribution were observed. Both cultures have been grown successfully on the hydrophilic wool.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A curable aqueous composition for use in a plant growth substrate, wherein said curable aqueous composition is formed in a process comprising combining the following components:
(a) a hydroxy-containing polymer,
(b) a multi-functional crosslinking agent which is at least one selected from the group consisting of a polyacid, salt(s) thereof and an anhydride, and
(c) a hydrophilic modifier;
wherein the weight ratio of (a):(b) is from 95:5 to about 35:65.

2. The curable aqueous composition of claim 1, wherein the (a) hydroxy-containing polymer is polyvinyl alcohol.

3. The curable aqueous composition of claim 1, having a nonvolatile content greater than 30 wt %.

4. The curable aqueous composition of claim 2, wherein the polyvinyl alcohol is 70 mole % to 99 mole % hydrolyzed.

5. The curable aqueous composition of claim 4, wherein the polyvinyl alcohol has a low molecular weight defined as a viscosity up to 10 centipoise when in a 4% aqueous solution at 20° C.

6. The curable aqueous composition of claim 1, wherein the multi-functional crosslinking agent is an acid comprising at least two carboxylic groups, an anhydride, or salt(s) thereof.

7. The curable aqueous composition of claim 6, wherein multi-functional crosslinking agent is at least one selected from the group consisting of critic acid, maleic acid, maleic anhydride, succinic acid, glutaric acid, malic acid, phthalic acid and phthalic anhydride.

8. The curable aqueous composition of claim 1, wherein the hydrophilic modifier is at least one low-molecular weight polyol compound selected from the group consisting of a sugar alcohol, monosaccharide, disaccharide and oligosaccharide.

9. The curable aqueous composition of claim 8, wherein the hydrophilic modifier is at least one compound selected from the group consisting of glycerol, sorbitol, glucose, fructose, sucrose, maltose, lactose, glucose syrup and fructose syrup.

10. A plant growth substrate comprising a nonwoven fiber in a cured binder wherein the plant growth substrate is formed in a process comprising combining nonwoven fibers with the curable aqueous composition of claim 1 to form a mixture and curing the mixture.

11. The plant growth substrate according to claim 10, wherein the process includes a step of diluting the curable aqueous composition with sufficient water so the curable aqueous composition has up to 6% by weight of nonvolatiles prior to the curing step.

12. The plant growth substrate according to claim 11, wherein the nonwoven fiber in fiberglass or mineral wool.

13. The plant growth substrate according the claim 11, in the form of a mat of mineral wool as the nonwoven fiber and the binder.

14. A method for forming a curable aqueous composition for use in a plant growth substrate, said method comprising the following steps:
combining (a) a hydroxy-containing polymer, (b) a multi-functional crosslinking agent which is at least one selected from the group consisting of a polyacid, salt(s) thereof, and an anhydride, and (c) a hydrophilic modifier; and
with the proviso that if the curable aqueous composition has a pH of below 1.25, then the method further comprises a step of adding sufficient base to raise the pH to at least 1.25; and
wherein the weight ratio of (a):(b) is from 95:5 to about 35:65.

15. The method according to claim 14, wherein the hydroxy-containing polymer is polyvinyl alcohol.

16. The method according to claim 14, wherein the curable aqueous composition has a nonvolatile content greater than 30 wt %.

17. A method of forming a plant growth substrate comprising the following steps:
combining (a) a hydroxy-containing polymer, (b) a multi-functional crosslinking agent which is at least one selected from the group consisting of a polyacid, salt(s) thereof, and an anhydride, and (c) a hydrophilic modifier; and
with the proviso that if the curable aqueous composition has a pH of below 1.25, then the method further comprises a step of adding sufficient base to raise the pH to at least 1.25; and
combining the curable aqueous composition with the nonwoven fiber, and heating the curable aqueous composition and the nonwoven fiber at 150° C. to 200° C. for sufficient time to effect cure,
wherein the weight ratio of (a):(b) is from 95:5 to about 35:65.

18. The method of claim 17, further comprising a step of diluting the curable aqueous composition with sufficient water so the curable aqueous composition has at least 95% by weight of water prior to the heating step.

19. The method according to claim 17, wherein the nonwoven fiber if fiberglass or mineral wool.
